(19) United States
(12) Patent Application Publication
(10) Pub. No.: US 2005/0022751 A1
(43) Pub. Date: Feb. 3, 2005

(54) Interactive Animal

(76) Inventor: Roland D. Nelson, Plymouth, MN (US)

Correspondence Address: Roger L. Belfay, 829 Tuscarora Avenue, Saint Paul, MN, 55102, US

(21) Appl. No.: 10/429,139

(22) Filed: May 2, 2003

(51) Int. Cl. A01K 29/00

(52) U.S. Cl. 119/709

(57) ABSTRACT

The interactive animal is a remote controlled toy comprising: a remote controlled powered vehicle, a detachable covering case configured to protect subjects from harm, and an attachment means fixed to the case permitting attachment of a variety of devices attractive to a subject such as livestock, pets or small children. The interactive animal is used remotely by an operator to train, entertain, or interact with subjects such as pets, children, or livestock by providing a wide variety of moving stimuli for the subject. One or more trailer vehicles may be flexibly attached to the powered vehicle to provide additional interest for the subject.

### DETAILED DESCRIPTION OF THE INVENTION

The toy of the present invention comprises two separate units. The first unit is a mechanically movable powered vehicle 8 with a detachably attached cover 3 provided with a means to attach a variety of lures devised to attract the attention of a subject. When the powered vehicle 8 is set in motion the attached lure is also set in motion further stimulating the interest of the subject through movement determined by the operator. The toy system of the present invention also includes one or more vehicles flexibly attached to the powered vehicle 8. The trailer vehicles are distinguished from the powered vehicle 8 by the absence of a motor and drive mechanism 7. The flexible attachment means between the powered vehicle 8 and the trailer vehicle 8 provides a means by which the powered vehicle 8 may tow or guide the trailer vehicle 8. The trailer vehicle 8 or powered vehicle 8 may be equipped with a second flexible attachment means thereby towing or guiding another trailer vehicle 8. This configuration can be repeated as often as the user desires creating a railroad train like caravan of as many powered 8 and trailer vehicles 8 as desired. The flexible attachment means supports electrical connections as required to support the control and power needs of whatever combination of lures 1 is provided on the various members of the caravan. The attachment means 12 between vehicles 8 may be placed on either or both ends of the case 3. The attachment means 11 may be placed on the axle of the steerable wheels 6. The attachment means 13 may be placed on the axle of the non-steerable wheels 5. The attachment means 11, 12 and 13 may appear in any combination on either or both ends of the vehicle 8 or case 3.

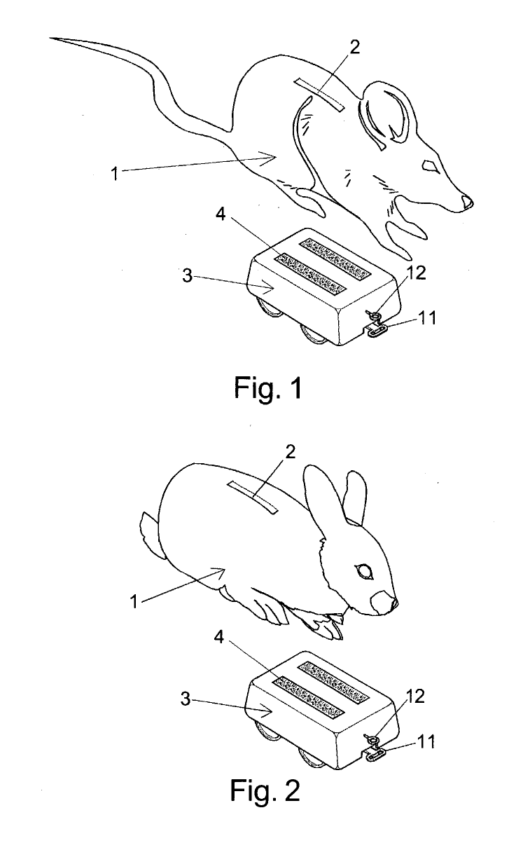

FIG. 1 depicts the case 3, a lure attachment means 4, and a mouse-like lure 1. The mouse-like lure 1 is attached by the lure attachment means 4 to the case 3. The case 3 is designed to minimize the risk of injury to subjects. The case 3 may be constructed of any material such as: rawhide, molded plastic, formable metal, sacrificial substances, transparent substances, or other suitable material or a combination of such materials. The mouse-like lure 1 is provided with appropriate mating parts of the lure attachment means 4. The mouse-like lure 1 includes a slot 2 for the insertion of negative and positive attractants such as food, scent, motion, sound, taste, touch, passions, fears, sights, or any other lure 1. The lure attachment means 4 consists of one or more of the following or combinations thereof. Velcro strips, snaps, screws, a track around the case 3, welding, a surface for placement of a lure 1, slots, grooves, Velcro straps affixed to the powered vehicle 8, magnets, springs, plugs, prongs, breakaway materials, nut-bolt combinations, two sided tape, single sided tape, surface depression, or adhesives. The lure attachment means 4 may also be an undetachable means such as incorporation in the case 4. The case 3 can be configured to permit amphibious operation of the interactive animal.

FIG. 2 depicts the case 3, a lure attachment means 4 and a rabbit-like lure 1. The rabbit-like lure 1 is attached by the lure attachment means 4 to the case 3. The case 3 is designed to minimize the risk of injury to subjects. The rabbit-like lure 1 is provided with appropriate mating parts of the lure attachment means 4. The rabbit-like lure 1 includes a slot 2 for the insertion of food or scented attractants. The lure 1 is not limited to rabbits and mice or even to rodents.

The lure 1 may be anything, which the user of the interactive animal determines to be attractive to the subject and to which a mating part of the attachment means is fixed. Stuffed animals, simulated food objects, brightly colored objects, slippers, globes containing additional attractants, and slippers containing food or animal treats, animal matter (sterilized wool), and plant matter (catnip) are examples of such items. Multiple lures are also be provided for. As indicated the globes may contain stuffed animals, brightly colored objects, living animals, nesting material, or any combination of these items. Living animals used within the globe may be any animals, which suit the user's purpose and further contain life support systems for these animals such as water for fish. Globes may be of any shape and may include mirrored surfaces to enhance the action of the matter contained within the globe or to visually isolate the living creatures within the globe to prevent or minimize their reaction to outside stimulants. To enhance the attractiveness of the lure 2 secondary motion such as rotation, swinging, launching projectiles, wagging, flapping, reflection, or popping up may be provided. The lure 1 or case 3, or vehicle 8 may include liquid ejection devices accomplishing such functions as squirting, misting, fogging, or other liquid dispensing techniques. The lure 1, case 3, or vehicle 8, may be provided with means to launch projectiles such as water balloons, ping-pong balls, food, food pellets, self propelled devices, guided devices, or guided self propelled devices. When equipped with a lure 1 which contains, dispenses or ejects food the interactive animal can be used as a feeder for the subject. The lure 1 may be provided with scent dispensing means such as pet hair, fur, or scent blocks. The lure 1 may be provided with items to exploit nurturant behavior such as sanitized wool, simulated maternal creatures, actual maternal creatures. The lure 1 may be comprised of objects exploiting nurturing behaviors such as simulated infant animals and actual infant animals. The lure 1 may be sacrificial for example: Chewable or soluble. The lure 1 may dispense treats, salt blocks, plant matter, or other objects the operator determines suitable for the subject. The lure may be provided with means to produce sounds such as barking, meowing, chirping, music, the subject's name, crackling of an empty plastic bottle, or the trainer's voice. The sound may be produced by a sound reproduction means or inherent to the selected lure 1. Some examples of inherent sound production means are an empty plastic bottle, a whistle embedded in the lure. Sound reproduction means may be either live or recorded as in a wireless communications system, or recorded as in a magnetic or electronic system or The lure 1 may be single or any combination of any number of lures 1 which the user can imagine and which the lure attachment means 3 can support in any given configuration. The lure 1 may comprise one or more other lures. The range of possible lures also includes some which are repellent in nature such as those providing: electric shock, startling lights, nipping actions, predators (owls for example), dry ice, fogs, high pressure water, hot water, cold water, steam, harmless smoke, toxic smoke, insecticides, insect repellents, predator scents, porcupine quills, sharp objects, offensive plant matter (marigolds for example), and sounds intended to produce fear in the subject. Any device offensive to one or more of the subjects' senses is a possibility. Lures can achieve many purposes such as pest removal. Pest removal by sealing, in plastic, for return to the user, for disposal or direct disposal is one example of this use. Lures themselves may be remotely controlled. One example is deployed squirt gun. A cavity provided in the case 3 or vehicle 8 provides a location for the lure attachment means 4. Lures 1 may be stacked upon lures aircraft carrier fashion. Lures 1 may be attached within lures like stacking dolls.

Use of the interactive animal is not limited to training, interaction, and game playing. Trapping, collaring, and marking are just a few of the additional uses. These uses extend to hard to reach places such as under decks or porches, around the home farm and factory. The Interactive Animal may accomplish chores or errands such as movement of waste containers. The Interactive Animal can entertain at parties, particularly when appropriately themed lures are provided such as: confetti, balloons (helium filled or otherwise), poppers, banners, and streamers.

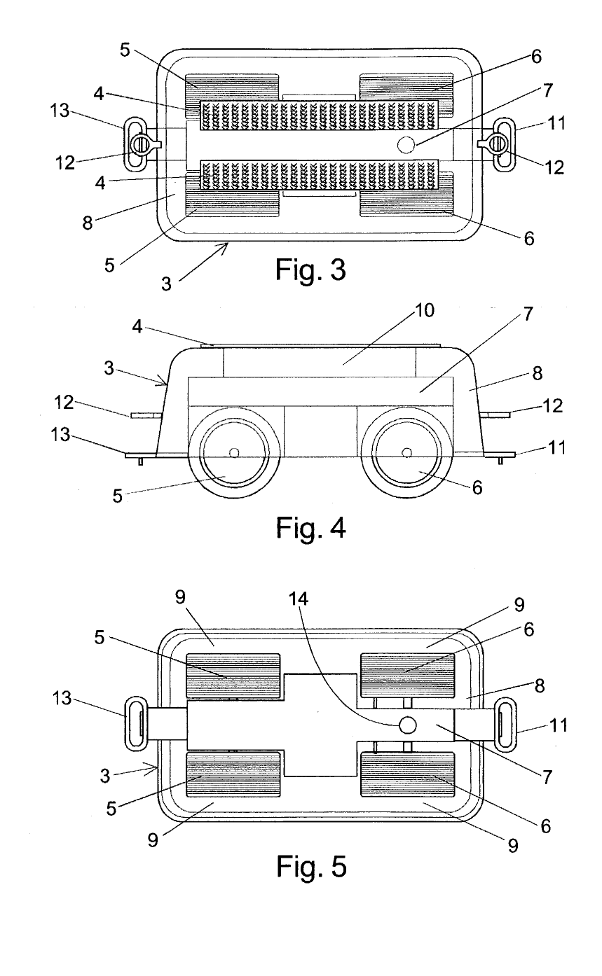

FIG. 3 is a transparent top view of the case 3, a lure attachment means 4, and the placement of the powered vehicle 8, under the case 3. FIG. 3 also shows placement of the lure attachment means 4 on the case 3. Many other placements of the lure attachment means 4 to the case 3 are possible such as on the top, sides front, or rear, of the case 3. Any desired combination of top, side, front, or rear placement of the lure attachment means 4 may be used as determined by the needs of any specific lure. The case 3 can be fitted with as many lure attachment means 4 as necessary to accommodate a given repertoire of lures. FIG. 3 depicts the placement of steering wheels 6 and rear wheels 5. FIG. 3 also shows the existence of a motor and drive mechanism 7 in the powered vehicle. The motor and drive mechanism is not present in the trailer vehicle 8. The powered vehicle 8 is an adapted radio controlled car, a remotely controlled vehicle designed specifically for this purpose, or any other device which can be modified to accept the vehicle attachment means 4 and achieve motion under the remote control of an operator through any means such as radio, infrared, sound, or ultra-sound. The power source of the powered vehicle 8 is any power source capable of powering the vehicle for its particular use. Some examples of power sources are: Capacitors, flywheels, CO₂ cartridges, solar energy, batteries, rechargeable batteries, animals, liquid fuel (gasoline for example) engines, and gas (propane for example) fueled engines. In any powered vehicle 8 or trailer vehicle 8 where safety is a consideration the power control system may include safety shutoff devices for situations where power shut off is of a benefit to the safety of the user or subject of the interactive animal, such as in a rollover situation or loss of control situation. In some embodiments the case 3 is removably attached to the vehicle 8. In other embodiments this attachment is permanent. In both cases access to the vehicle 8 for maintenance and power source replenishment may be by means other than removal of the case 3. The powered and trailer vehicles may be articulated. Steering may be accomplished through articulation.

FIG. 4 is a transparent side view of the case 3, a vehicle 8, and a vehicle attachment means 10 to attach the case 3 to the powered vehicle 8. FIG. 4 best illustrates one relationship between powered vehicle attachment means 10, the case 3, and the powered vehicle 8. FIG. 4 depicts the existence of a motor and drive mechanism 7 in the powered vehicle. The motor and drive mechanism is not present in trailer vehicles 8.

The vehicle attachment means 10 may be Velcro, snaps, screws, zipper, air hose connections, or any suitable material or devices, or combination thereof which provides detachable mechanical and an optional electrical connection between vehicle 8 and case to support whatever functionality the case 3 may implement. While the vehicle attachment means 10 is depicted on the top side of the vehicle 8 and the underside of the case 3 any relative positioning of the vehicle attachment means 10 on the vehicle 8 and case 3 may be used so long as the required mechanical and electrical connections are provided. The vehicle attachment means 10 may be comprised of several sub assemblies whose placement is determined by the mechanical and electrical vehicle 8 to case 3 connectivity requirements of one or more envisioned configurations of the interactive animal. The vehicle attachment means 10 may be in the form of an integration between the vehicle 8 and case 3 by imbedding the vehicle in a cast material to form the case 3 such as plastic or resin whereby said material might be sacrificed to access the vehicle for maintenance or power source replacement.

FIG. 5 is a bottom view of the case 3 and a powered vehicle 8. FIG. 5 best illustrates the small spacing 9 which must be controlled, among other parameters, to minimize the danger of injury to the broad range of subjects with which the interactive animal is used. FIG. 5 depicts the existence of a motor and drive mechanism 7 in the powered vehicle. The motor and drive mechanism 7 is not present in trailer vehicles. The vehicle 8 depicted in FIGS. 3, 4, and 5 is a four-wheeled motor driven vehicle in this embodiment. However, many other embodiments of the vehicles are included such as: flying vehicles, hovering vehicles, gliding vehicles, floating vehicles (positive buoyancy), sinking vehicles (negative buoyancy), variable buoyancy vehicles, controlled buoyancy vehicles, vehicles with 2, 3, 5 or more wheels, vehicles 8 with treads, vehicles with multiple steerable wheels, and any other vehicle which can effect locomotion. In some embodiments, it will be desirable to include a beacon to locate the position of the interactive animal. Such a beacon may be a part of the vehicle 8, case 3, or lure 1. Said beacon may also include a global positioning devise to broadcast the location of the device. In yet other embodiments recording of data by magnetic, electronic or other means may be a part of the vehicle 8, case 3, or lure 1.

FIG. 5 depicts the attachment of steerable wheels at a single pivot point 14. Other attachment means are also envisioned comprising: a rack and pinion steerable wheel assembly, a fixed center attachment with the wheels steerably attached at points off the centerline of the vehicle 8, or an axle and bearing or bearings. It is also envisioned that the center or rotation of the wheel may be behind, in front of, beneath, or above the pivot point 14.

1) A remotely controlled toy comprising:
(a) a remotely controlled powered vehicle,
(b) a covering case configured to protect children and animals from harm by the remotely controlled powered vehicle,
(c) an attachment means fixed to the covering case permitting attachment of a variety of devices attractive to pets or small children.

2) The toy of claim 1 further comprising a stuffed animal, attractive to dogs, attached by said means to said case.

3) The toy of claim 1 further comprising a stuffed animal, attractive to cats, attached by said means to said case.

4) The toy of claim 1 further comprising a stuffed animal, attractive to children, attached by said means to said case.

5) The toy of claim 1 further comprising a lure, motivating to dogs, attached by said means to said case.

6) The toy of claim 1 further comprising a lure, motivating to cats, attached by said means to said case.

7) The toy of claim 1 further comprising a lure, motivating to children, attached by said means to said case.

8) The toy of claim 1 further comprising a second vehicle with said second vehicle attached by flexible means to the remote controlled base vehicle.
